(19) United States
(12) Patent Application Publication
(10) Pub. No.: US 2005/0196982 A1
(43) Pub. Date: Sep. 8, 2005

(54) Land grid array connector with reliable securing blocks

(76) Inventors: Xisong Cao, Kunsan (CN); Wen He, Kunsan (CN); Nick Lin, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/025,524

(22) Filed: Dec. 28, 2004

(30) Foreign Application Priority Data
Mar. 5, 2004 (TW) 93105806

(51) Int. Cl. H01R 12/00

(52) U.S. Cl. 439/70

(57) ABSTRACT

A land grid array (LGA) connector (1) for connecting a land grid array (LGA) chip with a printed circuit board (PCB) includes a housing (10), and terminals (11) received in the housing. The housing defines a base (100) and four sidewalls (12, 13, 14, 15), the base and the sidewalls cooperatively defining a central receiving cavity (101) therebetween for receiving the LGA chip. The base has a number of passageways (102) along a length thereof, for receiving the corresponding terminals therein. Two adjacent sidewalls each define a resilient arm (120, 130) extending into the central cavity from an inner portion thereof. The other two adjacent sidewalls each define two securing blocks (140, 150) on an inner portion thereof. When the LGA chip is placed on the base, the resilient arms and the securing blocks can act on the LGA chip and cooperatively fix the LGA chip in the central cavity.

### BACKGROUND OF THE INVENTION

1. Field of the invention

The present invention relates to an electrical connector for electrically connecting an electronic package such as a land grid array (LGA) chip with a circuit substrate such as a printed circuit board (PCB).

2. Description of the prior art

Land grid array (LGA) electrical connectors are widely used in personal computers (PCs) for electrically connecting LGA chips to printed circuit boards (PCBs). As described in “Nonlinear Analysis Helps Design LGA Connectors” (Connector Specifier, February 2001, pp. 18-20), the LGA connector mainly comprises an insulative housing and a multiplicity of terminals. The housing comprises a multiplicity of terminal passageways defined in a generally rectangular array, for interferentially receiving corresponding conductive terminals. Due to the relatively high density of leads on a typical LGA chip, the LGA chip need to be precisely seated on the LGA connector to ensure reliable signal transmission between the terminals and the leads. Means for accurately attaching the LGA chip to the LGA connector is disclosed in U.S. Pat. Nos. 5,967,797 and 6,132,220.

Referring to FIG. 4, a conventional connector 6 comprises a substantially rectangular housing 60 and a multiplicity of conductive terminals 62 received in the housing 60. The housing 60 has four raised sidewalls 61, and a flat base 63 disposed between the four raised sidewalls 61. The base 63 and the sidewalls 61 cooperatively define a central cavity therebetween for receiving an LGA chip 7 therein. The base 63 defines a multiplicity of terminal passageways 630 for receiving the terminals 62 therein. A first resilient arm 611 is formed on one of the four sidewalls 61 and deformable in a first predetermined space 610 defined in the sidewall 61. Two spaced second resilient arms 612 are formed on another sidewall 61 adjacent the place where the first resilient arm 611 is formed. The second resilient arm 612 is capable of deformation in a second predetermined space 613 defined in another the sidewall 61. The first second resilient arms 611, 612 each have a chamfer surface 611 A, 612A respectively formed in an upper edge thereof for guiding insertion of the LGA chip 7 into the central cavity. The LGA chip 7 is fixed in the cavity by normal intervening force generated from the deformation of the resilient arms 611, 612.

In assembly, when the LGA chip 7 is placed in the base 63 of the housing 60, the LGA chip 7 touches the chamfer surface 611 A, 612A of the first and second arms 611, 612 before engaging with the first and second resilient arms 611, 612. Then the first and second arms 611, 612 are compressed by the LGA chip 7 and generate resilient forces in respective spaces 610, 613 to make the LGA chip 7 move to the other two sidewalls 61 respectively adjacent the ones on which the first and second resilient arms 611, 612 are formed. Thus the first and second resilient arms 611, 612 and the inner faces of the other two sidewalls 61 cooperatively secure the LGA chip 7 on the connector 1. As a result, mechanical and electrical engagement between the terminals 62 and corresponding leads (not shown) of the LGA chip 7 is attained.

However, when the LGA chip 7 is placed on the base 63 to engage the terminals 62, the first and second arms 611, 612 and the other two sidewalls 61 cooperatively secure the LGA chip 7 in the cavity. Because sides of the LGA chip 7 fully contact the inner faces of the other two sidewalls 61 thereby engagement area between the sides of the LGA chip 7 and the two sidewalls 61 is relatively large. As a result, the reliability engagement between the leads of the LGA chip 7 and the terminals 62 is decreased. If this happens, the LGA chip 7 can not be secured between the sidewalls 61 reliably, and some terminals 62 are prone not to fully engage the corresponding leads of the LGA chip 7. Uniform engagement between the terminals 62 and the corresponding leads of the LGA chip 7 is destroyed, and even open electrical circuits are liable to establish therebetween. Thus, reliability of mechanical and electrical engagement between the terminals 62 and the corresponding leads of the LGA chip 7 is decreased.

Therefore, a new land grid array connector which overcomes the above-mentioned problems is desired.

### SUMMARY OF THE INVENTION

An object of the present invention is to provide a land grid array connector for electrically connecting an LGA chip with a PCB, whereby the electrical connector is configured to ensure reliable engagement between the LGA chip and the connector.

Another object of the present invention is to provide a land grid array connector configured with securing blocks able to accurately secure the LGA chip on the connector.

To achieve the above objects, a land grid array (LGA) connector in accordance with a preferred embodiment of the present invention is applied for electrically connecting a land grid array (LGA) chip with a printed circuit board (PCB). The connector includes an insulative housing, and a multiplicity of conductive terminals received in the housing. The housing has four sidewalls and a flat base disposed between the sidewalls. The base and the sidewalls cooperatively defining a central cavity therebetween for receiving the LGA chip therein. The base defines a multiplicity of passageways along a length direction thereof, for receiving the corresponding terminals therein. Two adjacent sidewalls each define a first and second resilient arms on an upper edge thereof for guiding insertion of the LGA chip into the central cavity. The first and second resilient arms each have a chamfer surface at its distal end. The other two sidewalls adjacent the ones defining the first and second resilient arms each define two securing blocks extending from an inner side portion into the central cavity. The securing block defines a securing surface perpendicular to the central cavity for connecting sides of the LGA chip. With this configuration, when the LGA chip is received in the base and engages with the terminals, the first and second resilient arms and the securing surfaces of the securing blocks cooperatively and accurately secure the LGA chip on the housing under the arm's elasticity force. Engagement between the connector and the LGA chip is assured.

Other objects, advantages and novel features of the invention will become more apparent from the following detailed description taken in conjunction with the accompanying drawings, in which:

### BRIEF DESCRIPTION OF THE DRAWINGS

FIG. 1 is a simplified, exploded isometric view of a land grid array (LGA) connector in accordance with a preferred embodiment of the present invention, together with an LGA chip ready to be mounted on a base of the connector;

FIG. 2 is an assembled, isometric view of FIG. 1;

FIG. 3 is a top plan view of the LGA connector and the LGA chip mounted on the LGA connector; and

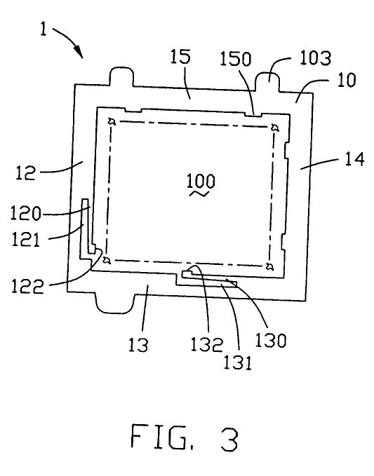

FIG. 4 is a simplified, exploded, isometric view of a conventional land grid array (LGA) connector, together with an LGA chip ready to be mounted on a base of the conventional connector.

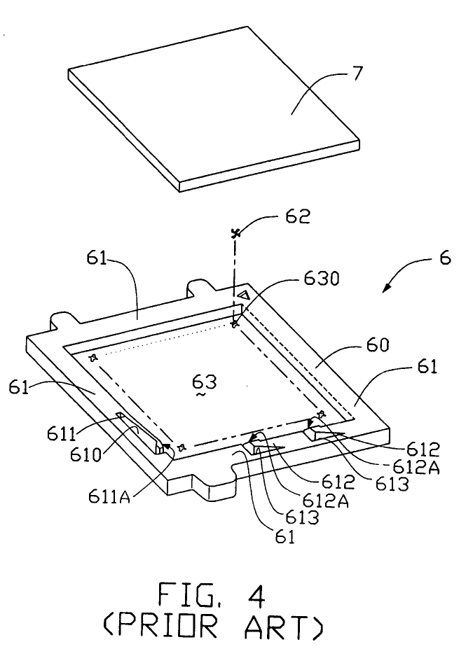

### DESCRIPTION OF THE PREFERRED EMBODIMENT OF THE INVENTION

Reference will now be made to the drawings to describe the present invention in detail.

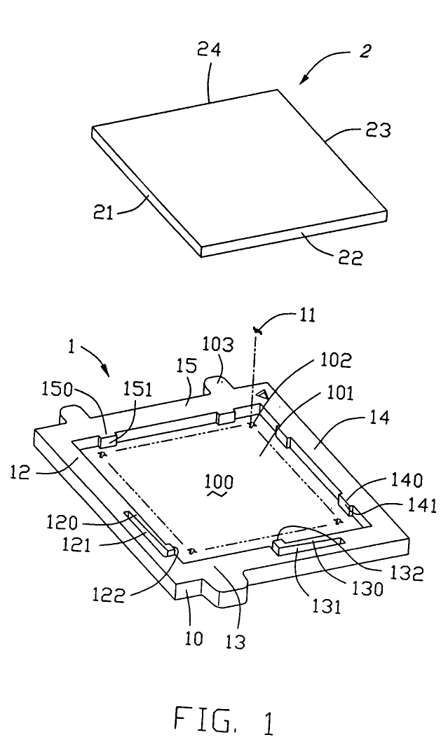

Referring to FIG. 1, a land grid array connector 1 in accordance with a preferred embodiment of the present invention is used for electrically connecting a land grid array (LGA) central processing unit (CPU) 2 with a printed circuit board (PCB) (not shown). The LGA CPU 2 is hereinafter referred to as the LGA chip 2. The connector 1 comprises an insulative housing 10, and a multiplicity of conductive terminals 11 received in the housing 10. The LGA chip 2 has a first side 21, a second side 22 adjacent the first side 21, a third side 23 opposite to the first side 21, and a forth side 24 opposite to the third side 23.

The housing 10 is substantially rectangular, and is formed from dielectric by molding. The housing 10 has a first sidewall 12, a second sidewall 13 adjacent the first sidewall 12, a third sidewall 14 opposite to the first sidewall 12, a forth sidewall 15 opposite to the second sidewall 13, and a flat base 100 disposed between the sidewalls 12, 13, 14, 15. The base 100 and the sidewalls 12, 13, 14, 15 cooperatively define a central cavity 101 therebetween for receiving the LGA chip 2 therein. The base 100 defines a multiplicity of terminal passageways 102 regularly arranged in a rectangular array around the cavity 101. The passageways 102 are for interferentially receiving corresponding terminals 11 therein. A first resilient arm 120 is formed on an inner side portion of the first sidewalls 12 and capable of deformation in a first space 121 defined in the first sidewall 12. A second resilient arm 130 is formed in an inner portion of the second sidewall 13 adjacent to the first sidewall 12. The second resilient arm 130 is capable of deformation in a second space 131 defined in the second sidewall 13. The first resilient arm 120 and the second resilient arm 130 each have a chamfer surface 122, 132 respectively formed in an upper edge thereof for guiding insertion of the LGA chip 2 into the central cavity 101. Two first securing blocks 140 are formed on an inner portion of the third sidewall 14, and two second securing blocks 150 are formed on an inner portion of the forth sidewall 15, for mechanically connecting with the third and forth sides 23, 24 of the LGA chip 2. A cross-section of the first and second securing blocks 140, 150 is rectangular. The first and second securing blocks 140, 150 respective have a first securing surface 141 and a second securing surface 151 perpendicular to a bottom surface of the base 100. A width of between the first securing surface 141 and the chamfer surface 122 of the first resilient arm 120 is somewhat smaller than that between the second side 22 and the forth side 24 of the LGA chip 2, while a width of between the second securing surface 151 and the chamfer surface 132 of the second resilient arm 130 is somewhat smaller than that between the first side 21 and the third side 23 of the LGA chip 2. Thus the LGA chip 2 is fixed in the central cavity 101 by normal force originated from the deformation of the resilient arms 120, 130. Three ears 103 extend from the second and forth sidewalls 13, 15 near three corners of the housing 10 respectively. Each ear 103 has a post (not shown) extending downward from a bottom face thereof, for engagingly fixing the connector 1 on the PCB.

In use, the connector 1 is pre-positioned on the PCB, with the posts of the connector 1 being received in the holes (not shown) of the PCB. The connector 1 is mounted on the PCB by using surface mount technology (SMT) or suitable mechanical tools.

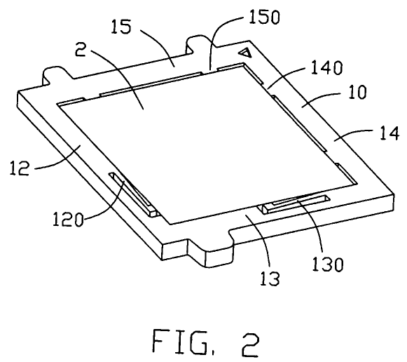

Referring to FIGS. 1 and 2, during insertion of the LGA chip 2 into the base 100 of the housing 10, the first and second sides 21, 22 of the LGA chip 2 respectively press the chamfer surfaces 122, 132 of the first and second resilient arms 12, 13, thereby the first and second resilient arms generate resilient forces in respective spaces 121, 131 so that the width of between the chamfer surface 122 and the first securing surface 141 is somewhat larger or equal to that between the first side 21 and the third side 23 of the LGA chip 2. This will make the LGA chip 7 move toward the third and forth sidewalls 14, 15 respectively to abut against the first and second securing surfaces 141, 151. Thus the resilient arms 120, 130 and the securing surfaces 141, 151 cooperatively secure the LGA chip 2 in the base 100 to electrically connect with the terminals 11.

When the leads of the LGA chip 2 engages with the terminals 11 of the connector 1, the first and second resilient arms 120, 130 and the first and second securing blocks 140, 150 connects with the corresponding sides 21, 22, 23, 24 of the LGA chip 2 with a relative small area compared with the conventional LGA connector. Thus reliably electrical engagement between the terminals 11 and the leads of the LGA chip 2 is attained.

Although the present invention has been described with reference to particular embodiment, it is not to be construed as being limited thereto. Various alterations and modifications can be made to the embodiment without in any way departing from the scope or spirit of the present invention as defined in the appended claims.

1. A land grid array connector for electrically connecting a first electrical device and a second electrical device, the land grid array connector comprising:
an insulative housing having a base and four sidewalls extending upwardly from the base, the base and the sidewalls cooperatively defining a central cavity for receiving the first electrical device therein, the base defining a generally rectangular array of passageways, at least one of the sidewalls defining a resilient arm on an inner portion thereof and capable of deformation in a positive space defined therein, at least one of the rest sidewalls defining securing blocks extending from an inner portion thereof into the central cavity, the securing block defining a securing surface perpendicular to a bottom surface of the base; and
a plurality of conductive terminals received in corresponding passageways for electrically engaging with the first electrical device and the second electrical device.

2. The land grid array connector as claimed in claim 1, wherein a cross-section of the securing block is rectangular.

3. The land grid array connector as claimed in claim 1, wherein the resilient arm has a cantilever-like configuration.

4. The land grid array connector as claimed in claim 3, wherein the resilient arm is formed with a chamfer surface on an upper edge thereof.

5. The land grid array connector as claimed in claim 4, wherein a width between the chamfer surface and the securing surface is somewhat smaller than that between opposite sides of the first electrical device.

6. A land grid array connector comprising:
an insulative housing defining a base and in sequence first, second, third and fourth side walls extending from the base and commonly forming a cavity therein, the first side wall being opposite to said third side wall, the second side wall being opposite to the fourth side wall;
a plurality of terminals disposed in the base with upper contacting tips extending upwardly into the cavity;
an electronic package disposed in the cavity;
each of said first and second side walls defining a resilient urging device to push the electronic package toward the corresponding third side wall and the fourth side wall; and
each of the third side wall and the fourth side wall defines a pair of spaced securing blocks each with thereon a securing surface which extends with a distance along a direction defined by the corresponding side wall and perpendicular to the base for engagement with the electronic package.

7. The land grid array connector as claimed in claim 6, wherein the pair of spaced securing blocks of the third side wall are close to the second side wall and the fourth side wall, respectively, and the pair of spaced securing blocks of the fourth side wall are close to the first side wall and the third side wall, respectively.
